(19) United States
(12) Patent Application Publication
(10) Pub. No.: US 2024/0362728 A1
(43) Pub. Date: Oct. 31, 2024

(54) HOTEL ROOM ONLINE MARKETPLACE FOR SELLING A PARTIAL BLOCK OF HOTEL ROOMS SELECTED FROM A BLOCK OF HOTEL ROOMS

(71) Applicant: RoomRite, Inc., Orlando, FL (US)

(72) Inventor: Michael Weiss, Orlando, FL (US)

(73) Assignee: RoomRite, Inc., Orlando, FL (US)

(21) Appl. No.: 18/631,481

(22) Filed: Apr. 10, 2024

Related U.S. Application Data
(60) Provisional application No. 63/461,618, filed on Apr. 25, 2023.

(51) Int. Cl. G06Q 50/12; G06Q 20/40

(52) U.S. Cl. CPC G06Q 50/12; G06Q 20/401

(57) ABSTRACT

The present invention relates to a hotel room online marketplace system, methods, and network that enables secondary buyers to purchase subsets of hotel rooms from hotel room block owners (block owners) that would otherwise go unused and assume the same contract terms as the block owners. Such contract terms can comprise a number of hotel rooms, a price for the number of hotel rooms, a room type, an occupancy date for the number of hotel rooms, and other terms. Fees can be collected and/or paid between the hotel, the block owner, and/or the secondary buyer. The marketplace can also curate third-party digital content to enhance the offer-for-sale listings and value proposition to secondary buyers.

### CROSS-REFERENCE TO RELATED APPLICATIONS

This application contains subject matter which is related to the subject matter of the following co-pending application. The below-listed application is hereby incorporated herein by reference in its entirety:

This is a U.S. non-provisional application that claims the benefit of a U.S. provisional application, Ser. No. 63/461,618, inventor Michael Weiss, entitled “HOTEL ROOM ONLINE MARKETPLACE FOR SELLING SUBSET BLOCKS OF GROUP BLOCKS OF HOTEL ROOMS”, filed Apr. 25, 2023.

### TECHNICAL FIELD OF THE INVENTION

This invention relates to a hotel room online marketplace system, methods, and network that enables secondary buyers to purchase subsets of hotel rooms from hotel room block owners (block owners) that would otherwise go unused and assume the same contract terms as the block owners.

### BACKGROUND OF THE INVENTION

Before our invention, a shortcoming was that there was no way for a block owner of a group of hotel rooms to sell a subset block of the unused rooms to a secondary buyer. While hotels are ultimately compensated for the unused/unfilled rooms in a block, they sometimes have to spend time and money on legal fees to collect balances owed by the block owners. The collection process can inadvertently strain the relationship between the hotel and the block owners, which can cost the hotel future business with that block owner.

The present invention addresses these and other shortcomings by providing a hotel room online marketplace where hotels have the ability to help their clients (hotel room block owners) fill/sell their excess inventory. This not only can help strengthen the relationship between the hotel and its clients, but it will also help the hotel develop relationships to create new business opportunities with the secondary buying groups who are buying rooms from their clients (hotel room block owners). For these reasons and shortcomings as well as other reasons and shortcomings there is a long-felt need that gives rise to the present invention.

### SUMMARY OF THE INVENTION

The shortcomings of the prior art are overcome and additional advantages are provided through the provision of a method of utilizing a hotel room online marketplace to enable a secondary buyer to purchase a subset of a block of hotel rooms from a block of hotel rooms owner who previously contracted for the block of hotel rooms. The method comprises the steps of creating, on a hotel room online marketplace, by a block of hotel rooms owner or by a hotel, an offer-for-sale listing that comprises a hotel property, an occupancy date, and a price for a partial hotel rooms block. The partial hotel rooms block comprises less than all of a block of hotel rooms previously contracted for by the block of hotel rooms owner. The partial hotel rooms block is offered under at least the same set of contract terms agreed to between the hotel and the block of hotel rooms owner.

The method continues by receiving, from a secondary buyer, by way of the hotel room online marketplace, responsive to the offer-for-sale listing, a request to purchase the partial hotel rooms block including agreeing to the contract terms. And, charging the secondary buyer the price for the partial hotel rooms block.

Additional shortcomings of the prior art are overcome and additional advantages are provided through the provision of a method of utilizing a hotel room online marketplace to enable a secondary buyer to purchase a subset of a block of hotel rooms from a block of hotel rooms owner who previously contracted for the block of hotel rooms. The method comprises the steps of creating, on a hotel room online marketplace, by a block of hotel rooms owner or by a hotel, an offer-for-sale listing that comprises a hotel property, an occupancy date, and a price for a partial hotel rooms block. The partial hotel rooms block comprises less than all of a block of hotel rooms previously contracted for by the block of hotel rooms owner. The partial hotel rooms block is offered under at least the same set of contract terms agreed to between the hotel and the block of hotel rooms owner.

The method continues by authorizing, by the hotel, the secondary buyer to purchase the partial hotel rooms block. Receiving, by way of the hotel room online marketplace, responsive to the offer-for-sale listing, from a secondary buyer, a request to purchase the partial hotel rooms block including agreeing to the contract terms. And, charging the secondary buyer the price for the partial hotel rooms block.

Additional shortcomings of the prior art are overcome and additional advantages are provided through the provision of a method of utilizing a hotel room online marketplace to enable a secondary buyer to purchase a subset of a block of hotel rooms from a block of hotel rooms owner who previously contracted for the block of hotel rooms. The method comprises the steps of creating, on a hotel room online marketplace, by a block of hotel rooms owner or by a hotel, an offer-for-sale listing that comprises a hotel property, an occupancy date, and a price for a partial hotel rooms block. The partial hotel rooms block comprises less than all of a block of hotel rooms previously contracted for by the block of hotel rooms owner. The partial hotel rooms block is offered under at least the same set of contract terms agreed to between the hotel and the block of hotel rooms owner.

The method continues by qualifying the secondary buyer as an authorized group with the capability to purchase based on a predetermined set of secondary buyer criteria. And, receiving, by way of the hotel room online marketplace, responsive to the offer-for-sale listing, from a secondary buyer, a request to purchase the partial hotel rooms block including agreeing to the contract terms.

The method continues by charging the secondary buyer the price for the partial hotel rooms block. And, distributing funds paid by the secondary buyer to the hotel and the block of hotel rooms owner when the partial hotel rooms block is purchased by the secondary buyer.

System and computer program products corresponding to the above-summarized methods are also described and claimed herein.

Additional features and advantages are realized through the techniques in the present invention. Other embodiments and aspects of the invention are described in detail herein and are considered a part of the claimed invention. For a better understanding of the invention with advantages and features, refer to the description and the drawings.

### BRIEF DESCRIPTION OF THE FIGURES

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a hotel room online marketplace system and network for selling partial blocks of hotel rooms;

FIG. 2 illustrates examples of computing devices and remote data processing resources;

FIG. 3 illustrates a database structure for a hotel room online marketplace system and methods of the present invention;

FIGS. 4-6 illustrate examples of screenshots of the present invention;

FIGS. 7-9 illustrate examples of a method of utilizing a hotel room online marketplace to enable a secondary buyer to purchase a subset of a block of hotel rooms from a block of hotel rooms owner who previously contracted for the block of hotel rooms; and

FIG. 10 illustrates exemplary embodiments that can be interchangeably used with the methods in the present invention.

The detailed description explains the preferred embodiments of the invention, together with advantages and features, by way of example with reference to the drawings.

### DETAILED DESCRIPTION OF THE INVENTION

The present invention creates an online secondary marketplace 100 also referred to as a hotel room online marketplace 100 for travel agents, meeting planners, tour operators, hotels, and others to buy and sell subset blocks of hotel rooms. The subset block of hotel rooms are portions less than all of a block of hotel rooms that have already been contracted for between a block of hotel rooms owner 102 (the client) and hotel 104. A block of hotel rooms owner 102 can be a person, organization, or other entity that has contracted with Hotel 104 to purchase a block of rooms for a future stay at a property. As can happen from time to time the block of hotel rooms owner 102 after contracting for the rooms, for a given date or dates, may not need all of the rooms and as such would be interested in selling the excess rooms as a partial hotel rooms block 114 to a qualified secondary buyer 106. Vendors 108 can also be an interested party to aid block owner 102 or hotel 104 in listing 116 as an offer-to-sell the partial hotel rooms block 114 in the hotel room online marketplace 100.

In this regard, the present invention provides a hotel room online marketplace 100 system, methods, and network that enable a secondary buyer 106 to purchase a subset of hotel rooms from the block of hotel rooms owner 102 and assume the same contract terms of the block of hotel rooms owner 102. Such contract terms can comprise the number of hotel rooms, a price for the number of hotel rooms, room types, an occupancy date for the number of hotel rooms, and other items as may be required and/or desired in a particular embodiment.

An advantage, in the present invention, is that in the group travel industry, it is common for a block of hotel rooms owner 102 (block owner 102/client) to sign a contract with one or more Hotels 104 to reserve a quantity number of rooms, often referred to as a block of rooms. When block owner 102 contracts a block of rooms from Hotel 104, they are typically required to guarantee the rooms held for them. Unfortunately, block owners 102 sometimes have more rooms than they need, in which case they ultimately pay Hotel 104 for unused/unfilled rooms. By using the hotel room online marketplace 100, block owner 102 will have the unique ability to list and sell their excess rooms on the open market to help reduce their financial obligation.

Another advantage, in the present invention, is that while some of block owners 102 have sufficient time to source and secure their room blocks through traditional channels, others do not. With relatively little notice, secondary buyers 106 are sometimes challenged to find and secure a sufficient number of rooms and/or reasonable rates at desirable hotels, especially in top-tier markets. By using the hotel room online marketplace 100, in the present invention, secondary buyers 106 can search availability and rates in real-time from the block owners 102, partial hotel rooms blocks that are available for purchase, and in inventory on marketplace 100. Secondary buyers 106 can book/reserve/purchase these partial hotel rooms blocks. By using the marketplace 100, the secondary buyer 106 groups who need to book blocks of hotel rooms on short notice will gain access to room availability and rates not found elsewhere.

Another advantage, in the present invention, is that hotels have the ability to include optional or mandatory add-on products/services to a resale listing. For example, and not a limitation, a mandatory add-on service might be a food & beverage credit. This would mean in order for the secondary buyer to purchase their sub-block of rooms, they must also prepay a specific dollar amount for food & beverage credits that are redeemable at the hotel's on-site bars, restaurants, etc. during the secondary buyer's stay.

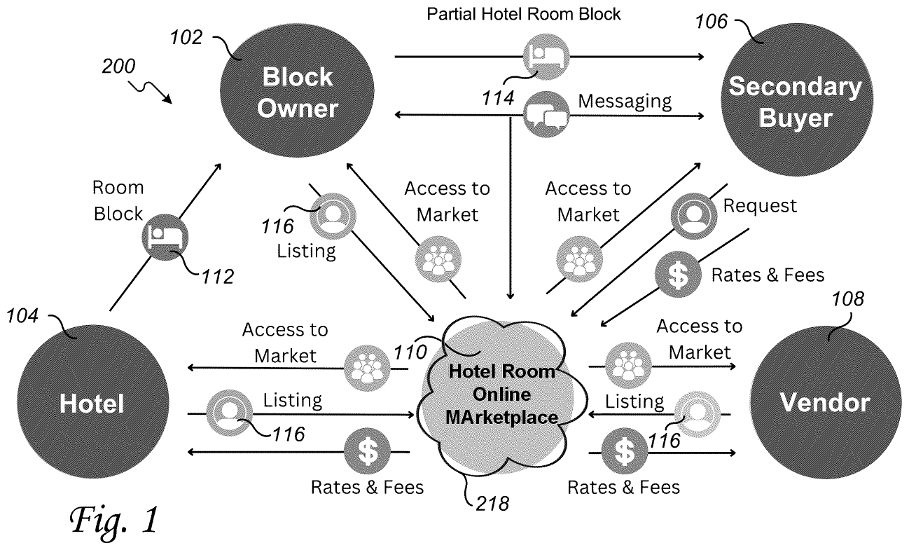

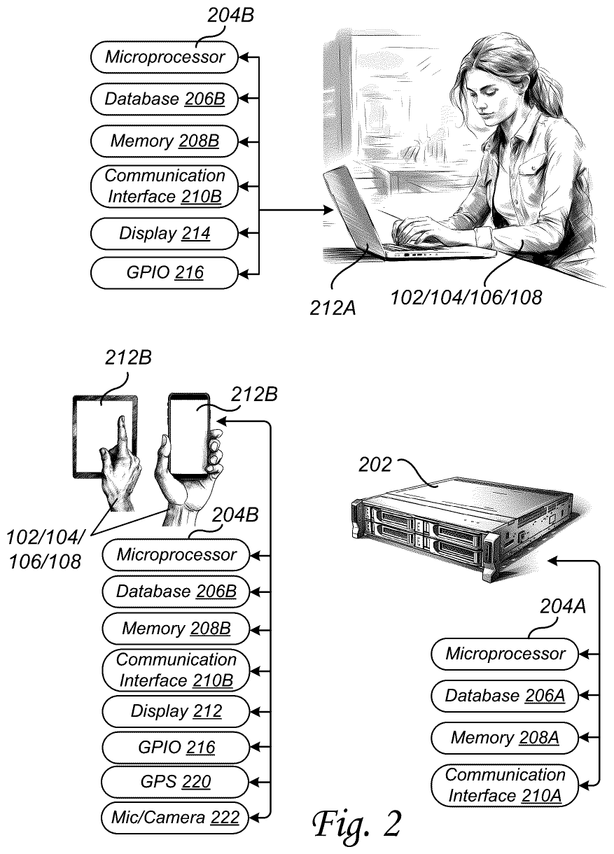

Turning now to the drawings in greater detail, it will be seen that in FIGS. 1 and 2 there is illustrated in FIG. 1 one example of a hotel room online marketplace 100 system and network for selling a partial block subset of a block of hotel rooms and in FIG. 2 examples of computing devices 212A and 212B and remote data processing resources 202.

In an exemplary embodiment, users of the network can include a block of hotel rooms owner 102 or block owner 102, a hotel 104, a secondary buyer 106, vendors 108, and other authorized persons or agencies or user groups, as may be required and/or desired in a particular embodiment.

Each of the users 102/104/106/108 uses computing devices 212A and 212B to data communicate over a global communication network 218 with one or more data processing resources 202. The computing devices 212A and 212B can be laptop computers, desktop computers, smartphones, tablets, or other types and kinds of computing devices, as may be required and/or desired in a particular embodiment. For disclosure purposes, computing devices can be referred to as computing devices 212.

Additionally, laptop and desktop types of computing devices 212 can be referred to as computing device 212A and smartphone and tablet types of computing devices 212 can be referred to as computing device 212B. The global communication network 218 can be the Internet.

The computing devices 212 can comprise a microprocessor 204B, a database 206B, memory 208B, a communication interface 210B, a display 214, and a plurality of general-purpose inputs and outputs (GPIO) 216. The microprocessor 204B is operationally related to database 206B, memory 208B, communication interface 210B, display 214, and GPIO 216. Computing devices 212B such as tablets, smartphones, and others) can comprise a global positioning system (GPS) 220, and a microphone and/or camera 222. In general, computing devices 212 can be configured with other functions and features, as may be required and/or desired in a particular embodiment. The computing devices 212 each rely on a suitable power source which can include a rechargeable battery, external power supply, or other types and/or kinds of power sources.

Microcontroller 204B can be INTEL, ZILOG, MICROCHIP, AMD, ARM, and/or other types or kinds of microprocessors.

Database 206B can be SQL, MYSQL, MARIADB, ORACLE, MS ACCESS, network-accessible storage, flat files, a combination thereof, or other types and kinds of databases.

The memory 208B can be a combination of random access memory (RAM), read only memory (ROM), flash, hard drives, solid-state drives, universal serial bus (USB) flash drives, micro-SD cards, or other types of removable memory, and/or other types and kinds of memory.

The communication interfaces 210B can be a local area network (LAN), a wide area network (WAN), USB, Ethernet, recommended standard 232 (RS232), recommended standard 485 (RS485), serial, Wi-Fi, 802.11abgn and similar, second generation (2G), third generation (3G), fourth generation (4G), fifth generation (5G) compatible, Bluetooth, transmission control protocol (TCP), user datagram protocol (UDP), Mesh Network, Zigbee, Pico Network, long-range navigation (LORAN), and/or other types and kinds of communication interfaces and protocols.

Display 214 can be a liquid crystal display (LCD), light emitting diode (LED), organic light emitting diode (OLED), or other types and kinds of displays.

General purpose inputs and outputs (GPIO) 216 can be transistor-to-transistor logic (TTL), complementary metal-oxide semiconductor (CMOS), metal-oxide-semiconductor field effect transistor (MOSFET), transistors, buffers, relays, pushbuttons, switches, and/or other types and kinds of GPIO circuits. In an exemplary embodiment, some of the GPIO 214 lines can be used to drive a touch screen input, biometric input devices, keyboards, and or types and kinds of computing device 212 input devices.

Global positioning system (GPS) device 220 can be used to determine the geographic location of user 102/104/106/108 who is carrying the computing device 212 equipped with the GPS 220. In this regard, such computing devices 212 are typically mobile computing devices such as tablets 212B, smartphones 212B, and other similar types and/or kinds of mobile computing devices 222.

Microphone and/or camera 218 can be used to record audio, and video, and take pictures. In this regard, users 302/304/306 can use their computing devices equipped with a microphone and/or camera 218 to make digital media records that can be selectively shared as appropriate in the Marketplace 100, on social media, and on other digital media outlet locations.

The data processing resource 202 can be a server, network storage device, or other types and kinds of data processing resources. Such data processing resources can be AMAZON WEB SERVICES (AWS), MICROSOFT AZURE, or other types and kinds of hosted data processing resource services. For disclosure purposes, a remote data processing resource 202 can also be referred to as server 202.

The data processing resource 202 can comprise a microprocessor 204A, a database 206A, memory 208A, and a communication interface 210A. The microprocessor 204A is operationally related to database 206A, memory 208A, and communication interface 210A.

Microcontroller 204A can be INTEL, ZILOG, MICROCHIP, AMD, ARM, and/or other types or kinds of microprocessors.

Database 206A can be SQL, MYSQL, MARIADB, ORACLE, MS ACCESS, network-accessible storage, flat files, a combination thereof, or other types and kinds of databases.

The memory 208A can be a combination of RAM, ROM, flash, hard drives, solid-state drives, USB flash drives, micro-SD cards, or other types of removable memory, and/or other types and kinds of memory.

The communication interfaces 210A can be LAN, WAN, USB, Ethernet, RS232, RS485, serial, Wi-Fi, 802.11abgn and similar, 2G, 3G, 4G, 5G compatible, Bluetooth, TCP, UDP, Mesh Network, Zigbee, Pico Network, LORAN, and/or other types and kinds of communication interfaces and protocols.

In an exemplary embodiment, the present invention creates a hotel room online marketplace 100 where authorized block owners 102 can create an offer-for-sale listing that features a subset number of their block of rooms, their contracted terms such as hotel property, occupancy dates, rates/price, room types, and other information. The entered listings are verified for accuracy and approved or otherwise published in the Marketplace 100. Secondary buyers 106 can view and purchase all or part of the listing's inventory. Secondary buyers 106 can also communicate with block owner 102 through the Marketplace 100 platform. Payments are accepted and distributed as needed through the Marketplace 100 platform. Block owners 102 will be prompted to upload a room list. Both the room lists and purchase requirements will be submitted to the hotel.

In operation, software executed on the data processing resource 202 and/or the computing devices 212 creates a hotel room online marketplace 100 that helps groups (block owners 102) and hotels 104 alike reduce or avoid the fallout associated with room block attrition. In this regard, the hotel room online marketplace 100 creates a unique capability for groups (block owners 102/clients) and hotels 104 to list and sell excess room block inventory on the open market.

An advantage, in the present invention, is that both parties the block owner 102 and the secondary purchaser 106 can save money in liquidated damages, legal fees, and other costs. The online secondary marketplace 100 will give secondary buyers 106 the unique ability to access room inventory and/or rates not found anywhere else. The additional room inventory and discounted group rates, not only benefit the secondary buyer 106 but also allow Hotels 104 to build relationships with new clients, for example, the secondary buyers 106, with whom they might not otherwise engage.

An advantage, in the present invention, is that the hotel room online marketplace 100 will allow third-party vendors 108, such as professional photographers, team-building establishments, and others to list and sell services on our platform, largely aimed at secondary buyers. The third-party vendor listings can access the hotel room online marketplace 100 through a variety of processes (manual entry, file [csv, json . . . ] upload, application programming interface (API) integration, and other ways).

As an added element of human interaction, the secondary buyer 106 can communicate with a live customer service representative to help answer questions or provide additional information and support.

In an exemplary embodiment, consumers can be added or otherwise join the hotel room online marketplace 100, under certain membership terms and conditions, as secondary buyers of individual rooms.

In another exemplary embodiment, public APIs can be implemented to allow secondary buyers to purchase rooms through an automated process rather than a manual process.

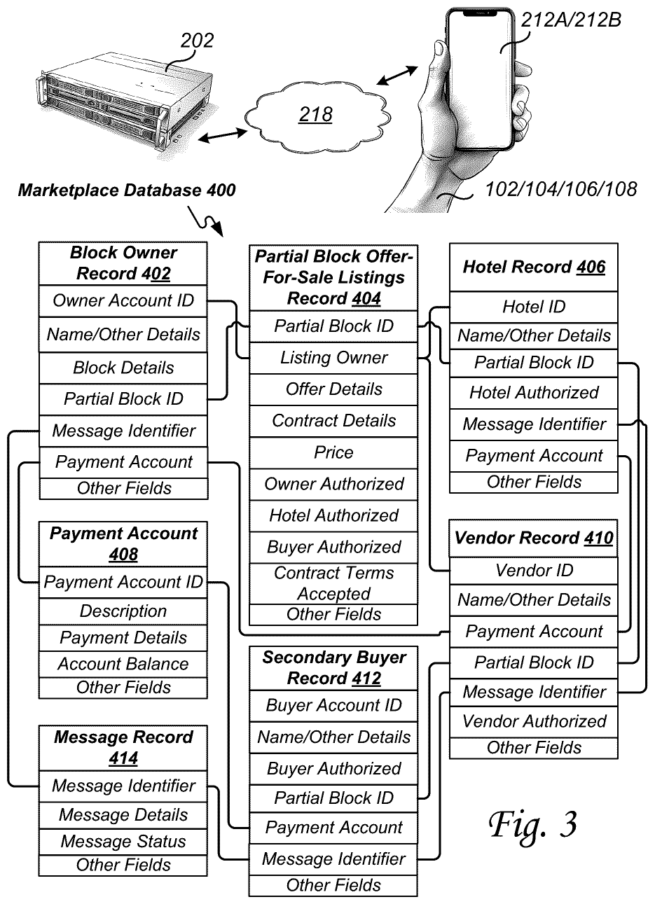

Referring to FIG. 3, there is illustrated one example of a database structure for a hotel room online marketplace system and methods of the present invention. In an exemplary embodiment, at least one database 206A/206B can be implemented on at least one of the data processing resources 202, server 202, or computing device 212. In operation, such one or more databases 206A/206B can be accessed/created/managed/maintained as appropriate and authorized by more than one stakeholder. In this regard, in addition to system administrators and other authorized persons, other stakeholders that can access/create/manage/maintain as appropriate at least parts of the marketplace database can include block owners 102, hotels 104, secondary buyers 106, vendors 108, administrators, and others as appropriate and authorized.

In an exemplary embodiment, such databases 206A/206B can be SQL, MYSQL, MARIADB, ORACLE, MS ACCESS, network-accessible storage, flat files, a combination thereof, or other types and kinds of databases.

In an exemplary embodiment, the marketplace database 400 can comprise a series of tables, records, fields, and accounts that include block owner record 402, partial block offer-for-sale listings record 404, hotel record 406, payment account record 408, vendor record 410, secondary buyer record 412, message record 414, and/or other types or kinds of records as may be required and/or desired in a particular embodiment. The interconnecting lines between certain fields within certain records 402/404/406/408/410/412/414 illustrate the data relationships between some of the fields and records.

In operation, block owner record 402 can comprise information related to the hotel room block owner 102 including an owner account ID, name/other details, the hotel room block details, the partial block ID associated with the partial block of the hotel rooms being listed for sale, message information, payment account details, and other information.

The partial block off-for-sale listings record 404 can comprise a partial block ID, the listing owner, offer details, contract details, price for the partial block of rooms, as required authorizations owner/hotel/buyer, an indication that contract terms have been accepted by the buyer, and other information.

Hotel record 406 can comprise a hotel ID, hotel name/other details, an indication hotel 104 is authorized to transact business in the marketplace 100, message details, payment account details, and other information.

The payment account record 408 can comprise a payment account ID, appropriate descriptions, payment details, account balances, and other information.

Vendor record 410 can comprise a vendor ID, vendor name/other details, payment account details, partial block IDs for the business that vendor 108 is associated with, message details, an indication that vendor 108 is authorized to transact business in the marketplace 100, and other information.

The secondary buyer record 412 can comprise a buyer account ID, the buyer name/other details, an indication that the secondary buyer 106 is authorized to transact business in the marketplace 100, partial block IDs for the business that vendor 108 is associated with, message details, and other information.

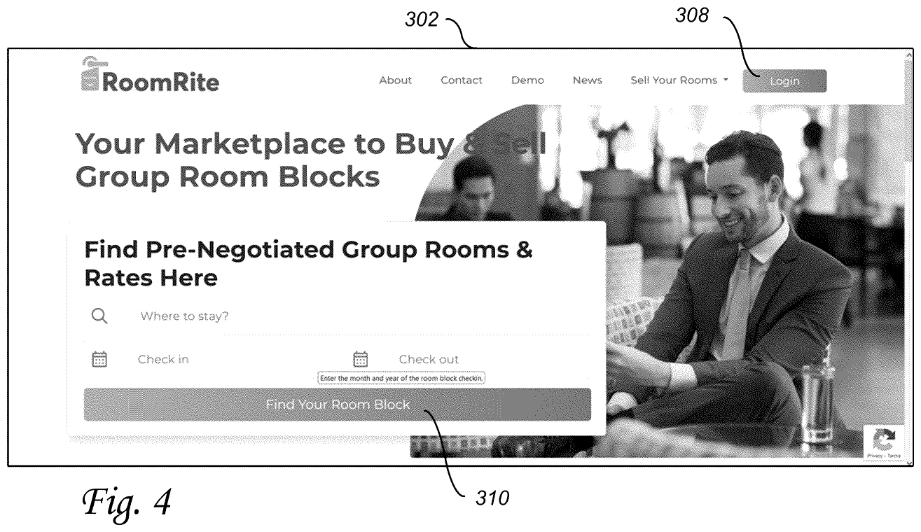

Referring to FIGS. 4-6, there are illustrated examples of screenshots of the present invention. Referring to FIG. 4 there is illustrated an initial welcome screenshot 302 to the ROOMRITE.IO hotel room online marketplace 100. In an exemplary embodiment, authorized users 102/104/106/108 can login 308 to the platform to transact business. Additionally, the landing page provides the ability for a visitor to Marketplace 100 to search 310 for partial block offer-for-sale listings that might be of interest to them.

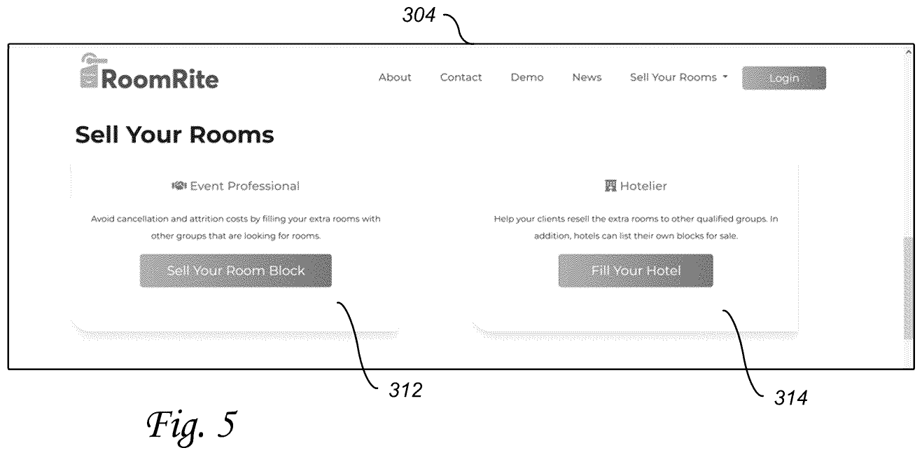

Referring to FIG. 5, there is illustrated an information page screenshot 304 that is tailored to information 312 to aid block owners 102 and information 314 to aid hotels 104 in listing and selling partial blocks of rooms in the marketplace 100.

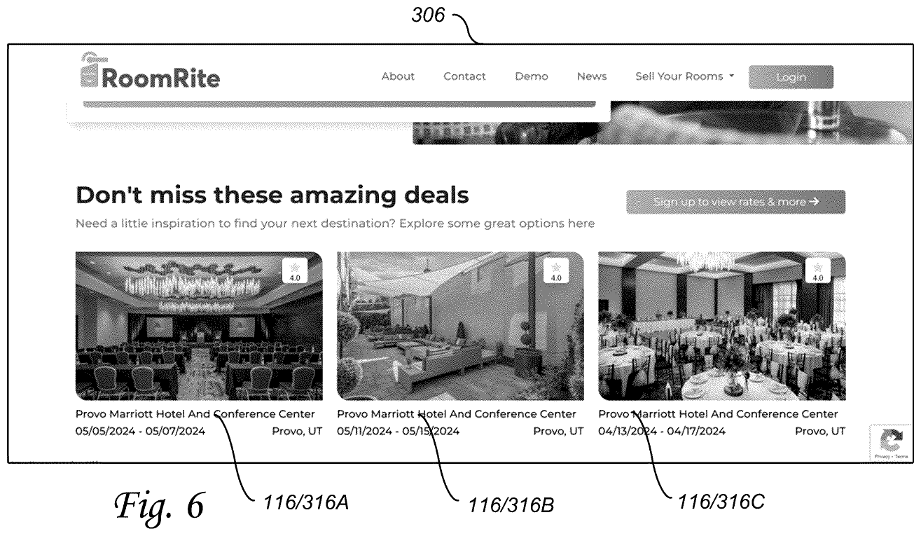

Referring to FIG. 6, there is illustrated a plurality of partial block offer-for-sale listings 116/316A-C. In an exemplary embodiment, such partial block offer-for-sale listings 116/316A-C can be selected by secondary buyers 106 to review details and transact reserving and/or otherwise purchasing the partial block of hotel rooms represented in the listing.

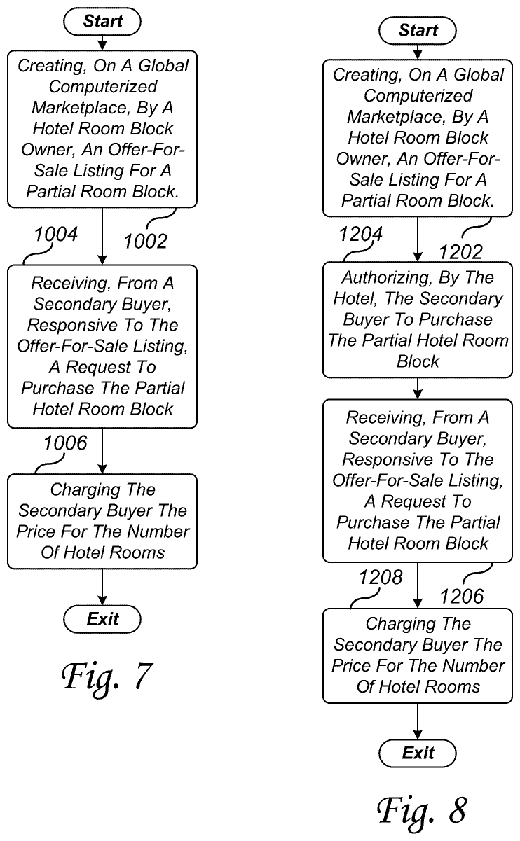

Referring to FIG. 7, there is illustrated one example of a method of utilizing a hotel room online marketplace 100 to enable a secondary buyer 106 to purchase a subset of a block of hotel rooms from a block of hotel rooms owner 102 who previously contracted for the block of hotel rooms from a hotel 104.

In an exemplary embodiment, to list and sell excess rooms in the marketplace 100, in the present invention, the block owner 102 or hotel 104 can create an account on the platform. Once logged in, the user 102/104 can create, read, update, or delete a listing. Listings include relevant information added by users 102/104, including the hotel name, room types and quantities, rates, dates, and more. These details are based on the block owner's 102 contract with Hotel 104. Additional details and assets are be pulled from third-party content resources using APIs, and other methods to enhance the listings. All listings are verified and approved by authorized parties 102/104 before they are published in the marketplace 100.

Secondary buyers 106 find block owner 102 listed subset room blocks by entering relevant search criteria, such as preferred occupancy dates, location, room quantities, and other information. The Marketplace 100, in the present invention, returns relevant and suggested listings based on the secondary buyer's 106 search criteria. Each listing has specific details about the hotel and available rooms. Secondary buyers 106 are required to create an account to purchase rooms from the listing, as well as to message block owner 102 with an inquiry. The Marketplace 100 accepts payment from the secondary buyer 106 and redistributes relevant fees to Hotel 104 and/or block owner 102 as required. Secondary buyers 106 are prompted and reminded to submit a rooming list with names and contact information for each room, which is then supplied to Hotel 104. The method begins in step 1002.

In step 1002, by a block of hotel rooms owner 102 or a hotel 104, an offer-for-sale listing that comprises a hotel property, an occupancy date, and a price is created on the hotel room online marketplace 100 for a partial hotel room block that comprises less than all of a block of hotel rooms under at least the same set of contract terms agreed to between a hotel 104 and the block of hotel rooms owner 102. In this regard, block owner 102 can create an offer-for-sale of a partial or subset of the total number of rooms that block owner 102 has already contracted for with hotel 104. Additionally, the offer-for-sale listing includes selling the subset of rooms to a secondary buyer 106 under at least the same contract terms that the block owner 102 agreed to with hotel 104.

In an exemplary embodiment, the contract terms can comprise a number of hotel rooms, a price for the number of hotel rooms, an occupancy date for the number of hotel rooms, room types, and other types and/or kinds of contract terms as may be required and/or desired in a particular embodiment. The method then moves to step 1004.

In step 1004, responsive to the offer-for-sale listing, a request to purchase the partial hotel rooms block including agreeing to the contract terms is received from a secondary buyer 106. The method then moves to step 1006.

In step 1006, the secondary buyer 106 is charged the price for the number of hotel rooms. In an exemplary embodiment, the price can be full price, a deposit, or other types of authorizations, guarantees, agreements, or fees, as may be required and/or desired in a particular embodiment. The method is then exited.

In an exemplary embodiment, the hotel room online marketplace 100 is unaffiliated with Hotel 104, the block of hotel rooms owner 102, and the secondary purchaser 106.

In an exemplary embodiment, the hotel room online marketplace 100 is operated on one or more server 202 with data communications between server 202 and a plurality of computing devices 212. The plurality of computing devices 212 are operated by Hotel 104, the block of hotel rooms owner 102, and the secondary buyer 106 which communicate over a global network 218. The global network can be the Internet.

Referring to FIG. 8, there is illustrated one example of a method of utilizing a hotel room online marketplace 100 to enable a secondary buyer 106 to purchase a subset of a block of hotel rooms from a block of hotel rooms owner 102 who previously contracted for the block of hotel rooms from a hotel 104. The method begins in step 1202 by creating, on a hotel room online marketplace 100, by a block of hotel rooms owner 102 or by hotel 104, an offer-for-sale listing 116 that comprises a hotel property, an occupancy date, and a price for a partial hotel rooms block. The partial hotel rooms block 114 comprises less than all of a block of hotel rooms previously contracted for by the block of hotel rooms owner 102. The partial hotel rooms block 114 is offered under at least the same set of contract terms agreed to between the hotel and the block of hotel rooms owner.

The method continues in step 1204 by authorizing, by the hotel 104, the secondary buyer 106 to purchase the partial hotel rooms block 114, and then in step 1206 receiving, by way of the hotel room online marketplace 100, responsive to the offer-for-sale listing 116, from a secondary buyer 106, a request to purchase the partial hotel rooms block 114 including agreeing to the contract terms.

The method continues in step 1208 by charging the secondary buyer the price for the partial hotel rooms block 114. In an exemplary embodiment, the price can be full price, a deposit, or other types of authorizations, guarantees, agreements, or fees, as may be required and/or desired in a particular embodiment. The method is then exited.

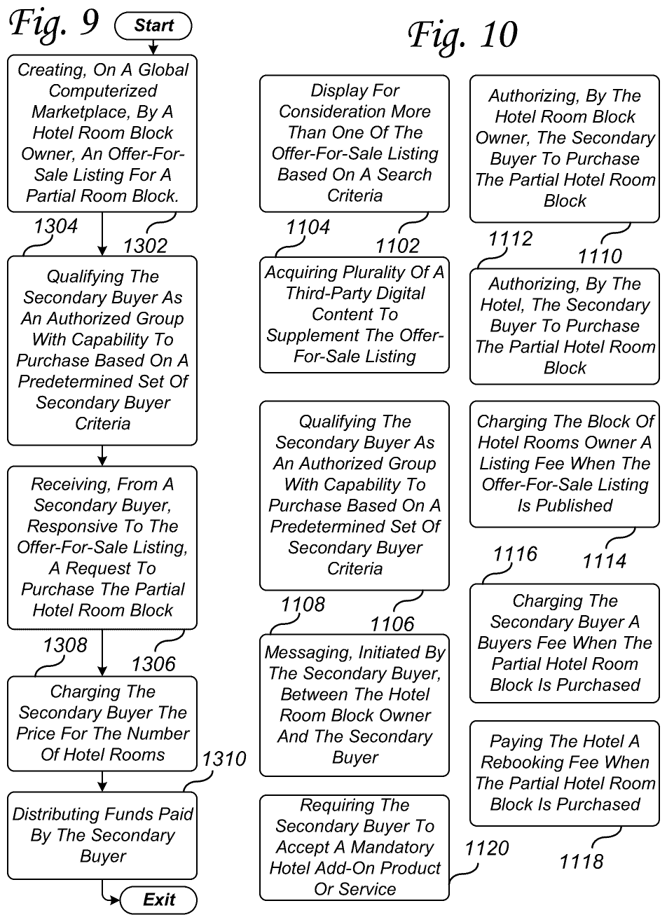

Referring to FIG. 9, there is illustrated one example of a method of utilizing a hotel room online marketplace 100 to enable a secondary buyer 106 to purchase a subset of a block of hotel rooms from a block of hotel rooms owner 102 who previously contracted for the block of hotel rooms from a hotel 104. The method begins in step 1302 by creating, on a hotel room online marketplace 100, by a block of hotel rooms owner 102 or by hotel 104, an offer-for-sale listing 116 that comprises a hotel property, an occupancy date, and a price for a partial hotel rooms block. The partial hotel rooms block 114 comprises less than all of a block of hotel rooms previously contracted for by the block of hotel rooms owner 102. The partial hotel rooms block 114 is offered under at least the same set of contract terms agreed to between the hotel and the block of hotel rooms owner.

The method continues in step 1304 qualifying the secondary buyer 106 as an authorized group with the capability to purchase based on a predetermined set of secondary buyer criteria.

The method continues in step 1306 receiving, by way of the hotel room online marketplace 100, responsive to the offer-for-sale listing 116, from a secondary buyer 106, a request to purchase the partial hotel rooms block 114 including agreeing to the contract terms.

The method continues in step 1308 by charging the secondary buyer the price for the partial hotel rooms block 114. In an exemplary embodiment, the price can be full price, a deposit, or other types of authorizations, guarantees, agreements, or fees, as may be required and/or desired in a particular embodiment.

The method continues in step 1310 by distributing the funds paid by the secondary buyer 106 to hotel 104 and block of hotel rooms owner 102 as appropriate when the partial hotel rooms block 114 is purchased by the secondary buyer 106. The method is then exited.

Referring to FIG. 10, there are illustrated exemplary embodiments that can be interchangeably used with the methods in the present invention.

In step 1102, more than one of the offer-for-sale listings is displayed for consideration to the secondary buyer 106 based on search criteria selected and initiated by the secondary buyer 106.

In step 1104, a plurality of third-party digital content is acquired to supplement the offer-for-sale listings. In this regard, the third-party content can comprise information related to the hotel, information related to events proximate to the hotel, advertisements or offers related to the hotel, businesses, or services proximate to the hotel, or other types and/or kinds of third-party content, as may be required and/or desired in a particular embodiment.

In step 1106, the secondary buyer 106 can be qualified as an authorized group with the capability to purchase based on a predetermined set of secondary buyer criteria.

In step 1108, messaging can be initiated by the secondary buyer 106, between the block of hotel room owner 102 and the secondary buyer 106.

In step 1110, authorizing, by the block of hotel rooms owner 102, the secondary buyer 106 to purchase the partial hotel rooms block.

In step 1112, authorizing, by hotel 102, the secondary buyer 106 to purchase the partial hotel rooms block.

In step 1114, the block of hotel room owner 102 is charged a listing fee when the offer-for-sale listing is published in Marketplace 100.

In step 1116, the secondary buyer 106 is charged a buyer's fee when the partial hotel rooms block is purchased.

In step 1118, hotel 104 is paid a rebooking fee when the partial hotel rooms block is purchased.

In step 1120, the secondary buyer 106 can be required to accept and pay for a mandatory hotel add-on produce or service. For example, and not a limitation, a mandatory add-on service might be a food & beverage credit. This would mean in order for the secondary buyer to purchase their sub-block of rooms, they must also prepay a specific dollar amount for food & beverage credits that are redeemable at the hotel's on-site bars, restaurants, etc. during the secondary buyer's stay

The capabilities in the present invention can be implemented in software, firmware, hardware, or some combination thereof.

As one example, one or more aspects in the present invention can be included in an article of manufacture (e.g., one or more computer program products) having, for instance, computer-usable media. The media has embodied therein, for instance, computer-readable program code means for providing and facilitating the capabilities in the present invention. The article of manufacture can be included as a part of a computer system or sold separately.

Additionally, at least one program storage device readable by a machine, tangibly embodying at least one program of instructions executable by the machine to perform the capabilities in the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention.

While the preferred embodiment of the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of utilizing a hotel room online marketplace to enable a secondary buyer to purchase a subset of a block of hotel rooms from a block of hotel rooms owner who previously contracted for the block of hotel rooms, the method comprising the steps of:
creating, on a hotel room online marketplace, by a block of hotel rooms owner or by a hotel, an offer-for-sale listing that comprises a hotel property, an occupancy date, and a price for a partial hotel rooms block, the partial hotel rooms block comprises less than all of a block of hotel rooms previously contracted for by the block of hotel rooms owner, the partial hotel rooms block is offered under at least the same set of a contract terms agreed to between the hotel and the block of hotel rooms owner;
receiving, from a secondary buyer, by way of the hotel room online marketplace, responsive to the offer-for-sale listing, a request to purchase the partial hotel rooms block including agreeing to the contract terms; and
charging the secondary buyer the price for the partial hotel rooms block.

2. The method in accordance with claim 1, the contract terms comprise a number of hotel rooms, a price for the number of hotel rooms, and an occupancy date for the number of hotel rooms.

3. The method in accordance with claim 1, further comprising:
displaying for consideration to the secondary buyer more than one of the offer-for-sale listing based on a search criteria selected and initiated by the secondary buyer;

4. The method in accordance with claim 1, further comprising:
acquiring plurality of a third-party digital content to supplement the offer-for-sale listing.

5. The method in accordance with claim 4, the third-party content comprises at least one of the following: information related to the hotel, information related to events proximate to the hotel, or advertisement or offers related to the hotel, businesses, or services proximate to the hotel.

6. The method in accordance with claim 1, further comprising:
qualifying the secondary buyer as an authorized group with the capability to purchase based on a predetermined set of secondary buyer criteria.

7. The method in accordance with claim 1, further comprising:
messaging, initiated by the secondary buyer, between the block of hotel rooms owner and the secondary buyer.

8. The method in accordance with claim 1, further comprising:
authorizing, by the block of hotel rooms owner, the secondary buyer to purchase the partial hotel rooms block.

9. The method in accordance with claim 1, further comprising:
authorizing, by the hotel, the secondary buyer to purchase the partial hotel rooms block.

10. The method in accordance with claim 1, further comprising:
charging the block of hotel rooms owner a listing fee when the offer-for-sale listing is published.

11. The method in accordance with claim 1, further comprising:
charging the secondary buyer a buyer's fee when the partial hotel rooms block is purchased; and
requiring the secondary buyer to accept and pay for a mandatory hotel add-on produce or service.

12. The method in accordance with claim 1, further comprising:
paying the hotel a rebooking fee when the partial hotel rooms block is purchased.

13. The method in accordance with claim 1, the hotel room online marketplace is unaffiliated with the hotel, the block of hotel rooms owner, and the secondary purchaser.

14. The method in accordance with claim 1, the hotel room online marketplace is operated on one or more of a server with data communications between the server and a plurality of computing devices, the plurality of computing devices are operated by the hotel, the block of hotel rooms owner, and the secondary buyer over a global network.

15. A method of utilizing a hotel room online marketplace to enable a secondary buyer to purchase a subset of a block of hotel rooms from a block of hotel rooms owner who previously contracted for the block of hotel rooms, the method comprising the steps of:
creating, on a hotel room online marketplace, by a block of hotel rooms owner or by a hotel, an offer-for-sale listing that comprises a hotel property, an occupancy date, and a price for a partial hotel rooms block, the partial hotel rooms block comprises less than all of a block of hotel rooms previously contracted for by the block of hotel rooms owner, the partial hotel rooms block is offered under at least the same set of a contract terms agreed to between the hotel and the block of hotel rooms owner;
authorizing, by the hotel, the secondary buyer to purchase the partial hotel rooms block;
receiving, by way of the hotel room online marketplace, responsive to the offer-for-sale listing, from a secondary buyer, a request to purchase the partial hotel rooms block including agreeing to the contract terms; and
charging the secondary buyer the price for the partial hotel rooms block.

16. The method in accordance with claim 15, further comprising:
qualifying the secondary buyer as an authorized group with the capability to purchase based on a predetermined set of secondary buyer criteria.

17. The method in accordance with claim 15, further comprising:
authorizing, by the block of hotel rooms owner, the secondary buyer to purchase the partial hotel rooms block.

18. The method in accordance with claim 15, further comprising:
paying the hotel a rebooking fee when the partial hotel rooms block is purchased.

19. A method of utilizing a hotel room online marketplace to enable a secondary buyer to purchase a subset of a block of hotel rooms from a block of hotel rooms owner who previously contracted for the block of hotel rooms, the method comprising the steps of:
creating, on a hotel room online marketplace, by a block of hotel rooms owner or by a hotel, an offer-for-sale listing that comprises a hotel property, an occupancy date, and a price for a partial hotel rooms block, the partial hotel rooms block comprises less than all of a block of hotel rooms previously contracted for by the block of hotel rooms owner, the partial hotel rooms block is offered under at least the same set of a contract terms agreed to between the hotel and the block of hotel rooms owner;
qualifying the secondary buyer as an authorized group with the capability to purchase based on a predetermined set of secondary buyer criteria;
receiving, by way of the hotel room online marketplace, responsive to the offer-for-sale listing, from a secondary buyer, a request to purchase the partial hotel rooms block including agreeing to the contract terms;
charging the secondary buyer the price for the partial hotel rooms block; and
distributing funds paid by the secondary buyer to the hotel and the block of hotel rooms owner when the partial hotel rooms block is purchased by the secondary buyer.

20. The method in accordance with claim 19, further comprising:
authorizing, by the block of hotel rooms owner, the secondary buyer to purchase the partial hotel rooms block; and
authorizing, by the hotel, the secondary buyer to purchase the partial hotel rooms block.
